(19) United States
(12) Patent Application Publication
(10) Pub. No.: US 2026/0137179 A1
(43) Pub. Date: May 21, 2026

(54) MULTI-FUNCTION WALKING CANE

(71) Applicant: Miguel Perez, San Antonio, TX (US)

(72) Inventor: Miguel Perez, San Antonio, TX (US)

(21) Appl. No.: 18/955,548

(22) Filed: Nov. 21, 2024

(51) Int. Cl. A45B 3/04; A45B 7/00; A45B 9/00; A45B 9/02; F21L 4/08; F21V 23/04; F21V 33/00; F21W 111/10; G01S 19/14; H04N 23/51; H04N 23/62

(52) U.S. Cl. CPC A45B 3/04; A45B 7/005; A45B 9/02; F21L 4/08; F21V 23/04; F21V 33/0068; G01S 19/14; H04N 23/51; H04N 23/62; A45B 2009/002; A45B 2009/007; F21W 2111/10

(57) ABSTRACT

A multi-function walking cane includes a rod and a foot attached to a first end of the rod. A handle is attached to a second end of the rod. The handle includes a front portion and a grip portion extending perpendicularly from the front portion above the rod. A camera is positioned in the front portion of the handle. The camera is selectively actuatable by a camera button on the handle. A microprocessor is positioned in the handle and connected to the camera to receive visual images from the camera. A battery is positioned in the handle and connected to the microprocessor and the camera.

### (b) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to walking canes and more particularly pertains to a new multi-function walking cane for providing a user of cane with multiple safety functions and other features. Persons who use canes are usually the elderly or disabled. The new multi-function walking cane includes such features as a camera to record potentially dangerous or threatening encounters with other persons, a global positioning system (GPS) unit to track the cane and the user, and a light to light the way in dark environments or at night.

### (2) Description of Related Art Including Information Disclosed Under 37 CFR 1.97 and 1.98.

The prior art relates to walking canes, many of which incorporate additional safety components. The prior art, as best understood, does not disclose a walking cane that includes a camera in a front portion of a handle of the walking cane that can be activated with the press of a button in the handle to record events occurring in front of the user of the cane, such as a confrontation with a potentially harmful person.

### (h) BRIEF SUMMARY OF THE INVENTION

An embodiment of the disclosure meets the needs presented above in a multi-function walking cane generally comprising a rod and a foot attached to a first end of the rod. A handle is attached to a second end of the rod. The handle includes a front portion and a grip portion extending perpendicularly from the front portion above the rod. A camera is positioned in the front portion of the handle. The camera is selectively actuatable by a camera button on the handle. A microprocessor is positioned in the handle and connected to the camera to receive visual images from the camera. A battery is positioned in the handle and connected to the microprocessor and the camera.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a multi-function walking cane and associated devices according to an embodiment of the disclosure.

FIG. 2 is a front view of a handle according to an embodiment of the disclosure.

FIG. 3 is a side cross-sectional view of the handle according to an embodiment of the disclosure.

FIG. 4 is a rear view of a lower portion of the multi-function walking cane according to an embodiment of the disclosure.

FIG. 5 is a cross-sectional view of the lower portion of the multi-function walking cane according to an embodiment of the disclosure.

FIG. 6 is a cross-sectional view of the lower portion of the multi-function walking cane according to an embodiment of the disclosure.

FIG. 7 is a perspective view of associated devices of an embodiment of the disclosure.

FIG. 8 is a side view of an embodiment of the disclosure in use.

### (J) DETAILED DESCRIPTION OF THE INVENTION

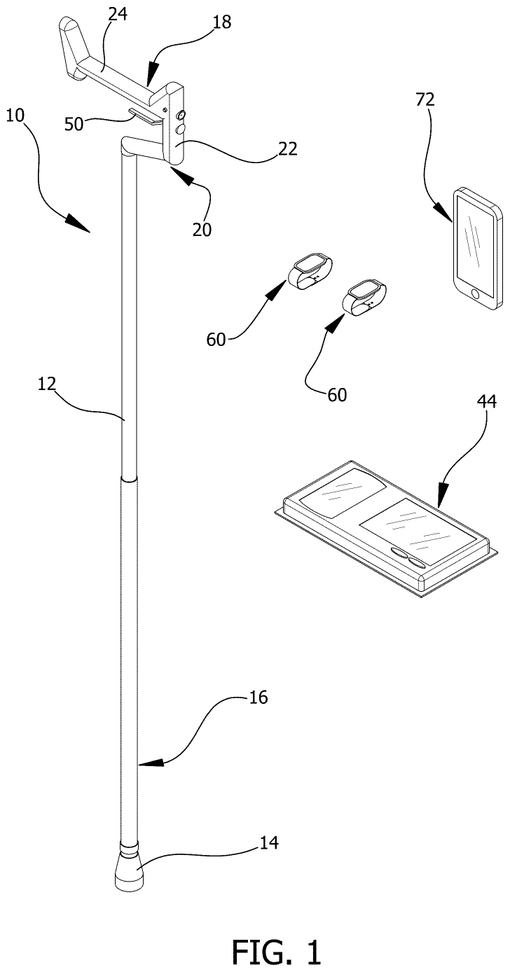

With reference now to the drawings, and in particular to FIGS. 1 through 8 thereof, a new multi-function walking cane embodying the principles and concepts of an embodiment of the disclosure and generally designated by the reference numeral 10 will be described.

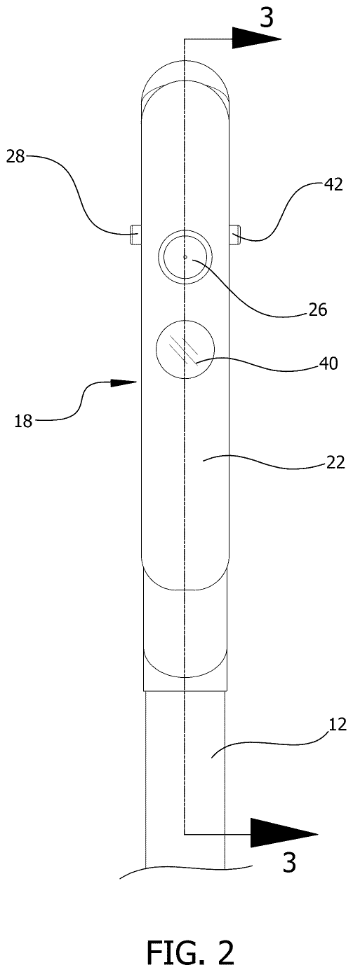

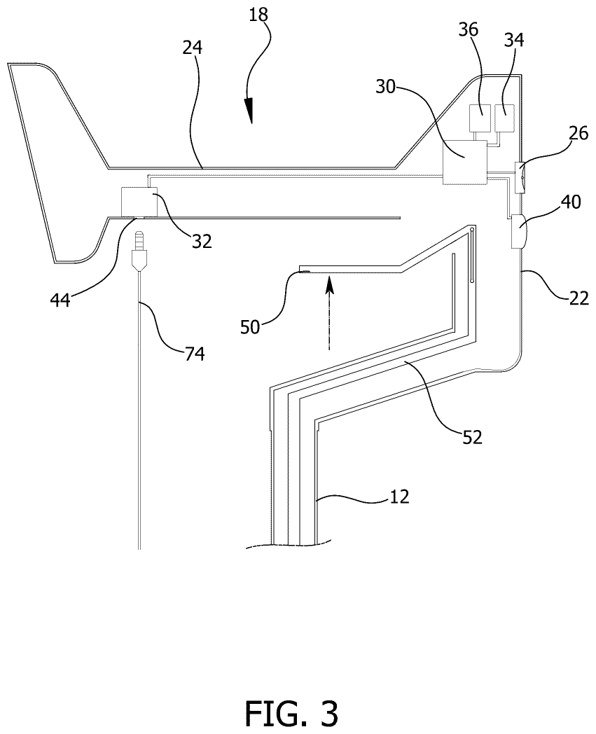

As best illustrated in FIGS. 1 through 8, the multi-function walking cane 10 generally comprises a rod 12 and a foot 14 attached to a first end 16 of the rod 12. A handle 18 is attached to a second end 20 of the rod 12. As shown in FIGS. 2 and 3, the handle 18 includes a front portion 22 and a grip portion 24 extending perpendicularly from the front portion 22 above the rod 12. A camera 26 is positioned in the front portion 22 of the handle 18. The camera 26 is selectively actuatable by a camera button 28 on the handle 18. A microprocessor 30 is positioned in the handle 18 and connected to the camera 26 to receive visual images from the camera 26. A battery 32 is positioned in the handle 18 and connected to the microprocessor 30 and the camera 26.

The camera 26 is used primarily as a safety device. If a user is in a potentially dangerous situation, such as being confronted by a person, the user can activate the camera 26 to record directly in front of the user. The user can then let the person know that he or she is being recorded, which may deter the person from acting inappropriately or illegally, and which will provide the user with a record of the encounter in the event law enforcement needs to be involved.

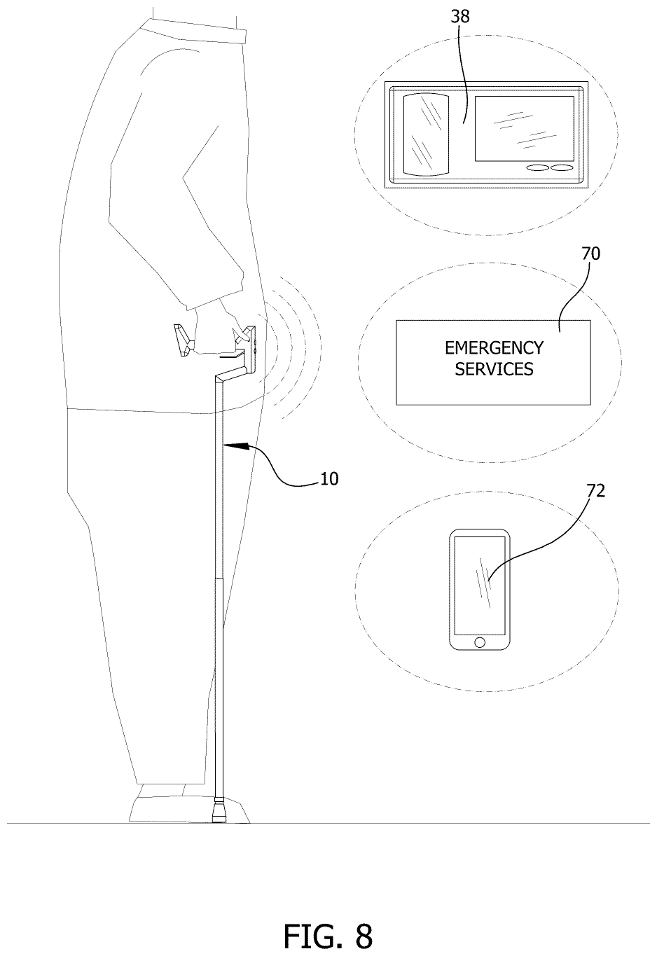

As shown in FIG. 3, the multi-function walking cane 10 further includes a global positioning system (GPS) unit 34 positioned in the handle 18 and connected to the microprocessor 30. A wireless transmitter 36 is positioned in the housing and connected to the microprocessor 30. The wireless transmitter 36 is designed to wirelessly transmit location data from the global positioning system unit 34. The microprocessor 30 is designed to automatically transmit global positioning system data to a predetermined receiver when the camera button 28 is pressed. The predetermined receiver could be a charging station 38, emergency services 70, or a personal electronic device 72, such as a smartphone, as shown in FIG. 8. The automatic transmission of location data would be helpful in a situation where the user is injured or, again, in a potentially dangerous situation involving another person. In one possible embodiment, the camera 26 could be connected to the wireless transmitter 36 to transmit live video or still images.

As shown in FIGS. 2 and 3, the multi-function walking cane 10 further includes a light 40 positioned in the front portion 22 of the handle 18. The light 40 is selectively actuatable by a light button 42 on the handle 18. The light 40 can be used to light the way in a dark area or at night. The multi-function walking cane 10 further includes a charging port 44 positioned in the handle 18. The battery 32 is rechargeable and connected to the charging port 44. A charging cord 74 can be inserted into the charging port 44.

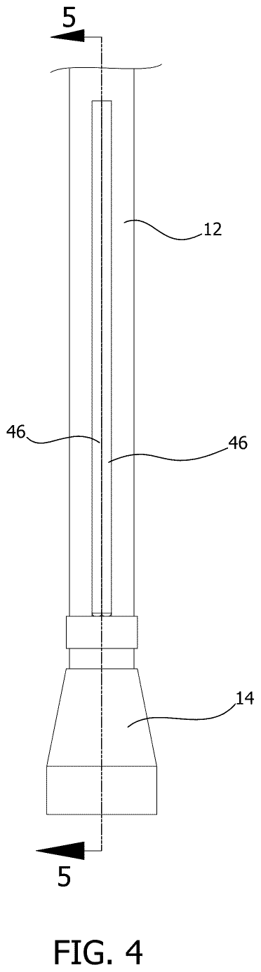

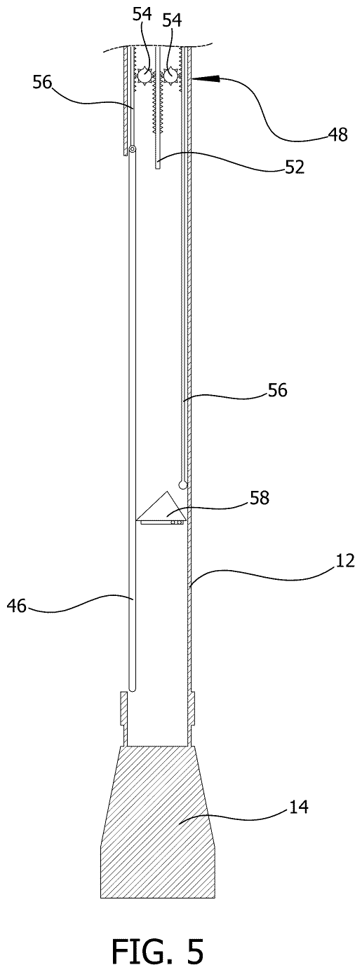

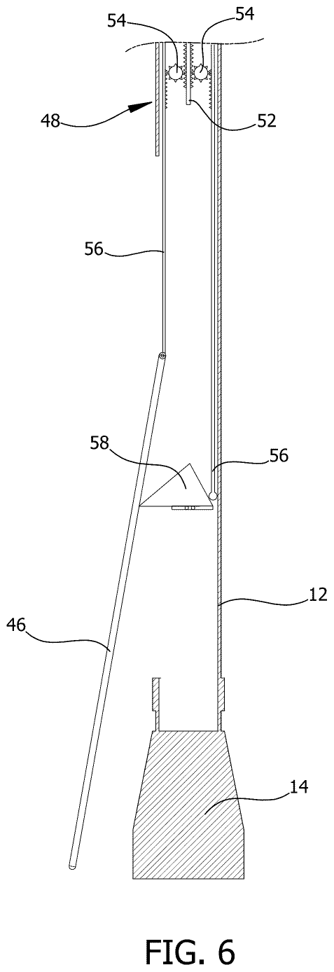

As shown in FIGS. 4 through 6, the multi-function walking cane 10 further includes a pair of legs 46 positioned in the rod 12 adjacent the foot 14. The legs 46 are designed to project out of the rod 12 at an angle to support the rod 12 in a vertical position. A lifter 48 is positioned in the rod 12. The lifter 48 is connected to the legs 46 to project and retract the legs 46. As shown in FIGS. 1 and 3, a lever 50 is positioned to project out of the handle 18 under the grip portion 24. The lever 50 is designed to be selectively squeezed to move the lifter 48 to selectively project and retract the legs 46. In use, the user squeezes the lever 50 which lifts the legs 46 so the user can tilt the legs 46 out of the rod 12, which enables the rod 12 to be stood up vertically rather than being leaned against a surface. FIGS. 5 and 6 show one exemplary embodiment of the lifter 48 that has an internal pull lever 52 connected by gears 54 to a pair of internal push levers 56. As shown in FIG. 3, the internal pull lever 52 is connected to the lever 50. With reference back to FIGS. 5 and 6, an angled sliding member 58 helps urge the legs 46 outwardly into an angled position. Other lifting mechanisms suitable for this function are well known in the mechanical arts, so the embodiments of the invention are not limited to the exemplary embodiment shown.

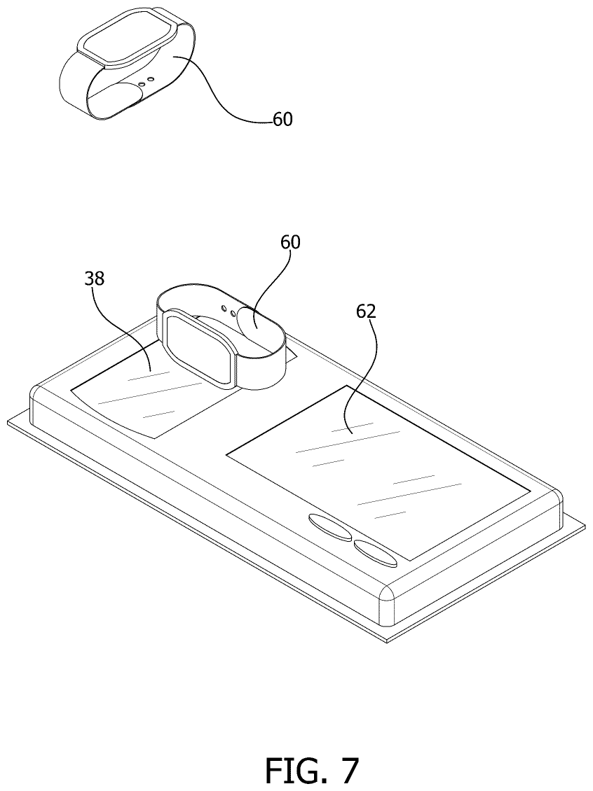

As shown in FIGS. 1 and 7, the multi-function walking cane 10 can be part of a multi-function walking cane 10 system that includes a wearable proximity sensor 60. The wearable proximity sensor 60 is connected to the microprocessor 30 by the wireless transmitter 36. The wearable proximity sensor 60 is designed to emit an alarm signal when the wearable proximity sensor 60 is moved beyond a predetermined distance from the walking cane. This will help the user not forget the multi-function walking cane 10. In the exemplary embodiment, the wearable proximity sensor 60 is a bracelet. An additional wearable proximity sensor 60 could be given to another user, such as a family member or caregiver, and the two wearable proximity sensors 60 could be linked to generate an alarm signal if the cane user moves beyond a predetermined distance from the other user. The wearable proximity sensor 60 could also include a GPS system to transmit location data.

The multi-function walking cane 10 system further includes the charging station 38 designed to charge the wearable proximity sensor 60. The charging station 38 includes a display 62 designed to show location data received from the global positioning system unit 34. The charging station 38 could therefore charge the wearable proximity sensor 60 as well as provide a way for a family member or caregiver to be informed of the location of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multi-function walking cane comprising:
a rod;
a foot being attached to a first end of said rod;
a handle being attached to a second end of said rod, said handle including a front portion and a grip portion extending perpendicularly from said front portion above said rod;
a camera being disposed in said front portion of said handle, said camera being selectively actuatable by a camera button on said handle;
a microprocessor being disposed in said handle and connected to said camera to receive visual images from said camera; and
a battery being disposed in said handle and connected to said microprocessor and said camera.

2. The multi-function walking cane of claim 1, further comprising:
a global positioning system unit being disposed in said handle and connected to said microprocessor; and
a wireless transmitter being disposed in said housing and connected to said microprocessor, said wireless transmitter being configured to wirelessly transmit location data from said global positioning system unit.

3. The multi-function walking cane of claim 2, wherein said microprocessor is configured to automatically transmit global positioning system data to a predetermined receiver when said camera button is pressed.

4. The multi-function walking cane of claim 1, further comprising a light being disposed in said front portion of said handle, said light being selectively actuatable by a light button on said handle.

5. The multi-function walking cane of claim 1, further comprising:
a pair of legs being disposed in said rod adjacent said foot, said legs being configured to project out of said rod at an angle to support said rod in a vertical position;
a lifter being disposed in said rod, said lifter being connected to said legs to project and retract said legs; and
a lever being disposed to project out of said handle under said grip portion, said lever being configured to be selectively squeezed to move said lifter to selectively project and retract said legs.

6. The multi-function walking cane of claim 1, further comprising a charging port positioned in said handle, wherein said battery is rechargeable and connected to said charging port.

7. The multi-function walking cane of claim 3, further comprising a light being disposed in said front portion of said handle, said light being selectively actuatable by a light button on said handle.

8. The multi-function walking cane of claim 7, further comprising:
a pair of legs being disposed in said rod adjacent said foot, said legs being configured to project out of said rod at an angle to support said rod in a vertical position;
a lifter being disposed in said rod, said lifter being connected to said legs to project and retract said legs; and
a lever being disposed to project out of said handle under said grip portion, said lever being configured to be selectively squeezed to move said lifter to selectively project and retract said legs.

9. The multi-function walking cane of claim 8, further comprising a charging port positioned in said handle, wherein said battery is rechargeable and connected to said charging port.

10. A multi-function walking cane system comprising:
a walking cane including:
a rod;
a foot being attached to a first end of said rod;
a handle being attached to a second end of said rod, said handle including a front portion and a grip portion extending perpendicularly from said front portion above said rod;
a camera being disposed in said front portion of said handle, said camera being selectively actuatable by a camera button on said handle;
a microprocessor being disposed in said handle and connected to said camera to receive visual images from said camera;
a battery being disposed in said handle and connected to said microprocessor and said camera;
a global positioning system unit being disposed in said handle and connected to said microprocessor; and
a wireless transmitter being disposed in said housing and connected to said microprocessor, said wireless transmitter being configured to wirelessly transmit location data from said global positioning system unit; and
a wearable proximity sensor, said wearable proximity sensor being connected to said microprocessor by said wireless transmitter, said wearable proximity sensor being configured to emit an alarm signal when said wearable proximity sensor is moved beyond a predetermined distance from said walking cane.

11. The multi-function walking cane system of claim 10, wherein said wearable proximity sensor is a bracelet.

12. The multi-function walking cane system of claim 11, further comprising a charging station configured to charge said wearable proximity sensor.

13. The multi-function walking cane system of claim 12, wherein said charging station includes a display configured to show location data received from said global positioning system unit.

14. The multi-function walking cane system of claim 13, wherein said microprocessor is configured to automatically transmit global positioning system data to a predetermined receiver when said camera button is pressed.

15. The multi-function walking cane system of claim 14, further comprising a light being disposed in said front portion of said handle, said light being selectively actuatable by a light button on said handle.

16. The multi-function walking cane system of claim 15, further comprising:
a pair of legs being disposed in said rod adjacent said foot, said legs being configured to project out of said rod at an angle to support said rod in a vertical position;
a lifter being disposed in said rod, said lifter being connected to said legs to project and retract said legs; and
a lever being disposed to project out of said handle under said grip portion, said lever being configured to be selectively squeezed to move said lifter to selectively project and retract said legs.

17. The multi-function walking cane system of claim 16, further comprising a charging port positioned in said handle, wherein said battery is rechargeable and connected to said charging port.
